(19) United States
(12) Patent Application Publication
(10) Pub. No.: US 2016/0059745 A1
(43) Pub. Date: Mar. 3, 2016

(54) Automatic Child Car Seat Safety Harness Tightening and Indication Systems

(71) Applicant: Christopher Carl Whitcombe, Newark, DE (US)

(72) Inventor: Christopher Carl Whitcombe, Newark, DE (US)

(21) Appl. No.: 14/789,119

(22) Filed: Jul. 1, 2015

Related U.S. Application Data
(60) Provisional application No. 62/044,205, filed on Aug. 30, 2014.

(51) Int. Cl. B60N 2/28

(52) U.S. Cl. CPC B60N 2/2812; B60N 2002/2815

(57) ABSTRACT

Systems are disclosed for a child car seat harness that is properly tightened automatically. Additionally, the child car seat harness may be manually tightened until a system indicates that the safety harness has been properly tightened

### CROSS-REFERENCE TO RELATED APPLICATIONS

This application claims priority from U.S. Provisional Patent Application Number 62/044,205 filed Aug. 30, 2014 incorporated herein in its entirety by this reference.

### FIELD OF THE INVENTION

The present invention relates to the field of infant or child car seats. Specifically, to systems in which the child car seat safety harness is tightened and an alert given.

### BACKGROUND OF THE INVENTION

Child car seats are legally required in every state in the United States. Once a child is placed in a car seat and buckled in, the safety harness needs to be tightened properly to adequately protect the child. A harness that's too tight may make breathing difficult for the child. The more likely scenario is a harness that is too loose which may cause injuries to the child in the event of a car crash. The looser the harness is on the child, the greater the chances of the child being ejected from the car seat. Manufacturers have several different methods to test for proper tightening, but all these tests rely on human judgment. For instance, one common practice is the “harness pinch test” which requires the user to pinch the harness straps. If the user is able to form a loop or fold in the straps, the harness is too loose. Another test is a finger test which requires the user to place his or her fingers under the harness at the collarbone level. If more than one or two fingers can fit under the harness, it is too loose. These methods are somewhat subjective and may be totally omitted in actual everyday use.

According to a 2001 study by the National Safe Kids Campaign, more than 200 children under the age of 5 were killed in car crashes while in their car seats. More specifically and according to a 2012 survey done by the National Highway Traffic Safety Administration (NHTSA), “a loose harness’ was one of the top 5 most significant and common mistakes made when using car seats. Consequently, what is needed is a system which automatically or otherwise indicates to the caretaker that the child car seat harness has been properly tightened.

It is an object of the present invention to provide methods for mechanized or automatic tightening of a child car seat safety harness. It is an object of the present invention to provide methods for indicating that a child car seat safety harness has been properly tightened. It is an object of the present invention to provide methods combining the above mentioned.

U.S. Pat. No. 5,061,012 to Parket, et al., issued Oct. 29, 1991, discloses a child car seat having a pivotal barrier interconnected to a harness assembly. This pivotal barrier is what is used to properly restrain the child rather than the harness assembly itself.

U.S. Pat. No 20120074758 A1 to Gates et al., issued Mar. 29, 2012 discloses a child safety seat harness tensioning device using springs, plungers, and ratchets to tighten a typical five point harness to the proper level. However, it does not include a dynamic or powered automatic or semi-automatic means to properly tighten the harness. In addition, outside of a tension indicator, it does not include other means to indicate to the caretaker that the safety harness had reached a proper level of tightening.

### SUMMARY OF THE INVENTION

Aspects of the present invention are directed to ensuring the safety of children in car seats, specifically to properly tightening the safety harness automatically. Caretakers may also be more at peace knowing that a system has indicated to them that the safety harness is properly tightened.

One aspect of the present invention provides a means to automatically tighten a child car seat safety harness using a tightening device such as a pressurized tension assembly or a motorized tension assembly. Another aspect of the present invention provides a means to indicate to the caretaker that proper tightening of the child car seat safety harness has been achieved. These and other aspects of the present invention may or may not be combined into a single system. Additionally, the aspects of the present invention may be built into the car seat, retrofitted into an existing car seat, or even be a separate, stand-alone device.

### BRIEF DESCRIPTION OF THE DRAWINGS

Other features of the present invention will become apparent in, but not limited to, the following detailed descriptions with reference to the accompanying drawings, of which:

FIG. 1 is a rear view of a child car seat with a motor mounted in the base of the child car seat.

FIG. 2 is a cross sectional view of FIG. 1 with a loose or untightened safety harness.

FIG. 3 is a cross sectional view of FIG. 1 with a tightened safety harness.

FIG. 4 is a rear view of a child car seat with an air pump and air cylinders to automatically tighten the safety harness.

FIG. 5 is a cross sectional view of the FIG. 4 with a loose or untightened safety harness.

FIG. 6 is a cross sectional view of the FIG. 4 with a tightened safety harness.

FIG. 7 is a rear view of a child car seat with a cantilevered load cell tension roller.

FIG. 8 is a cross sectional view of FIG. 7 with a loose or untightened safety harness.

FIG. 9 is a cross sectional view of FIG. 7 with a tightened safety harness.

FIG. 10 is a side cross sectional view of a child car seat with pneumatic bladders positioned under the shoulder straps of a safety harness.

FIG. 11 is a side cross sectional view of a child car seat with a pneumatic bladder positioned between the rear side of the car seat and the safety harness.

### DESCRIPTION OF ILLUSTRATIVE EMBODIMENTS

The following is a detailed description of illustrative embodiments of the invention with reference to the drawings wherein the same reference labels are used for the same or similar elements.

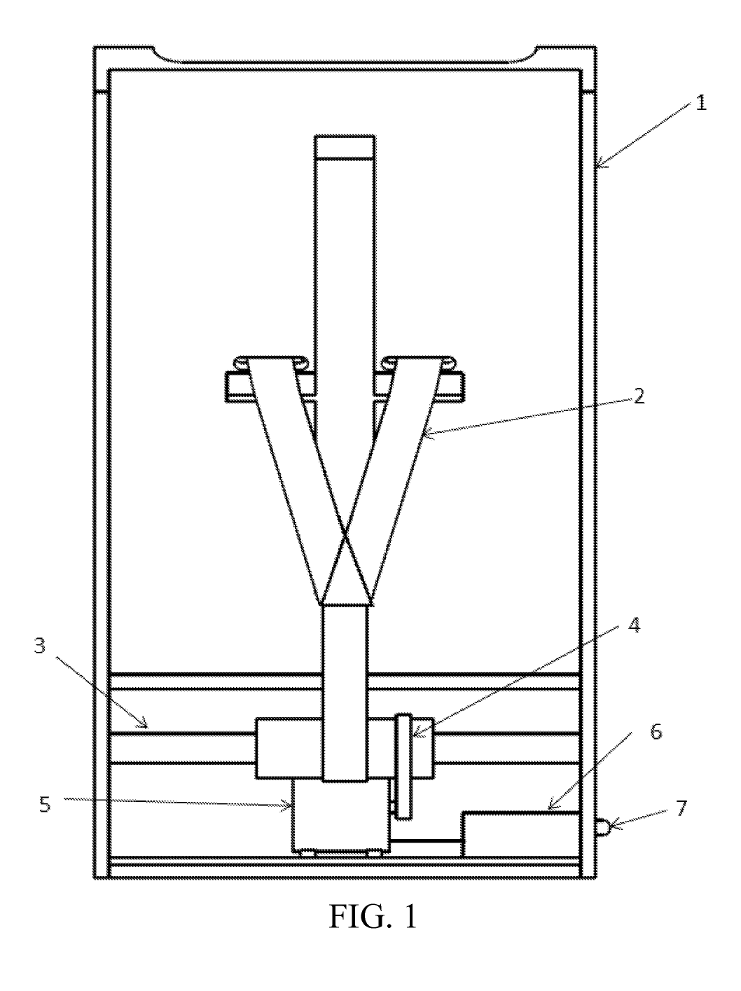

In FIGS. 1 to 3, 1 is a car seat; 2 is a safety harness; 3 is a windup shaft; 4 is a motor belt; 5 is a motor; 6 is an electronics unit; 7 is a switch and 8 is a lap buckle.

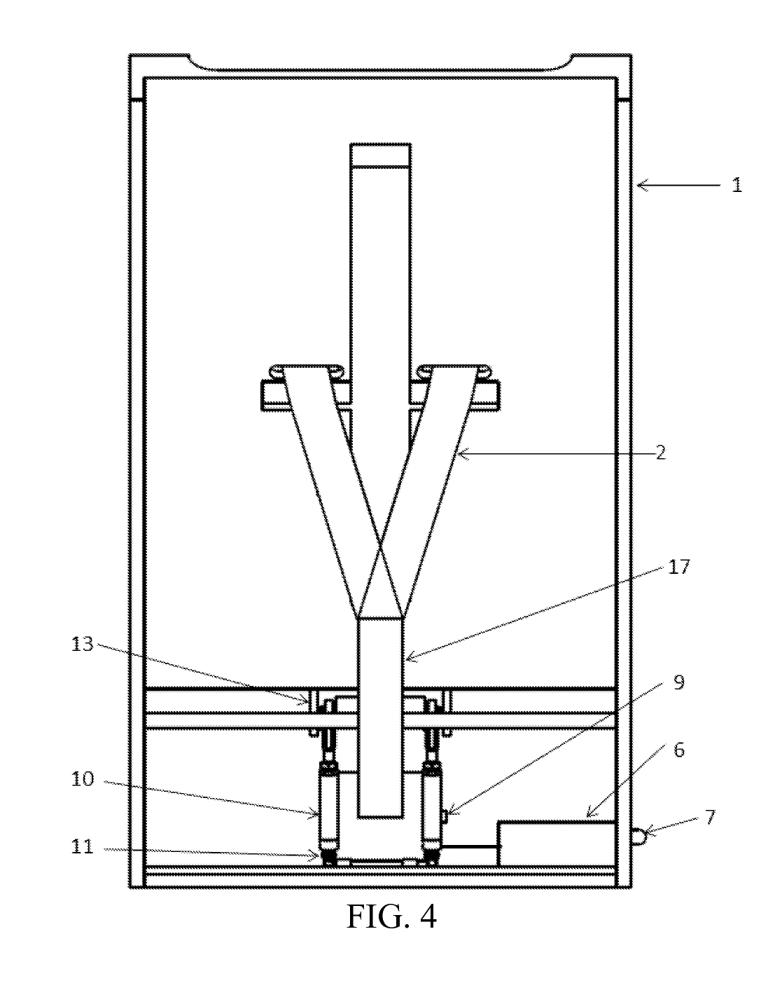

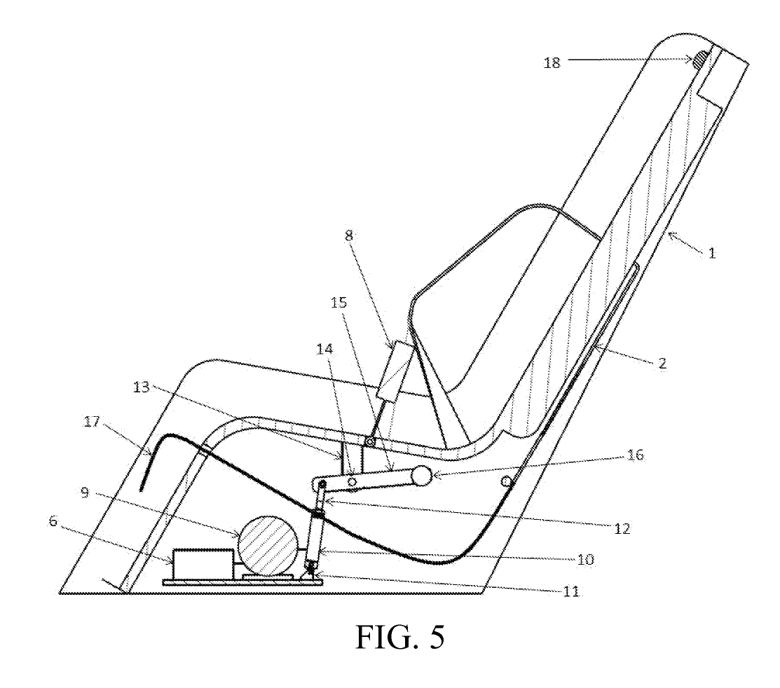

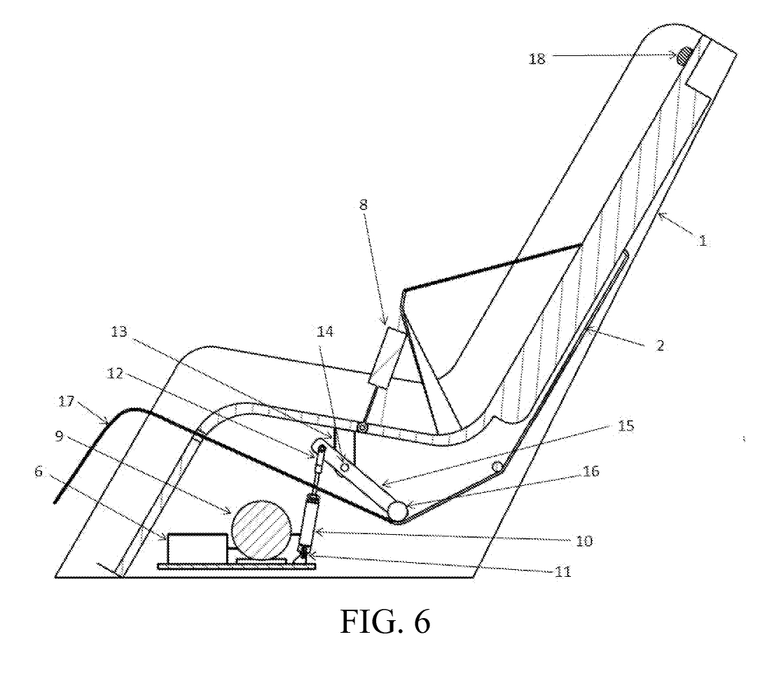

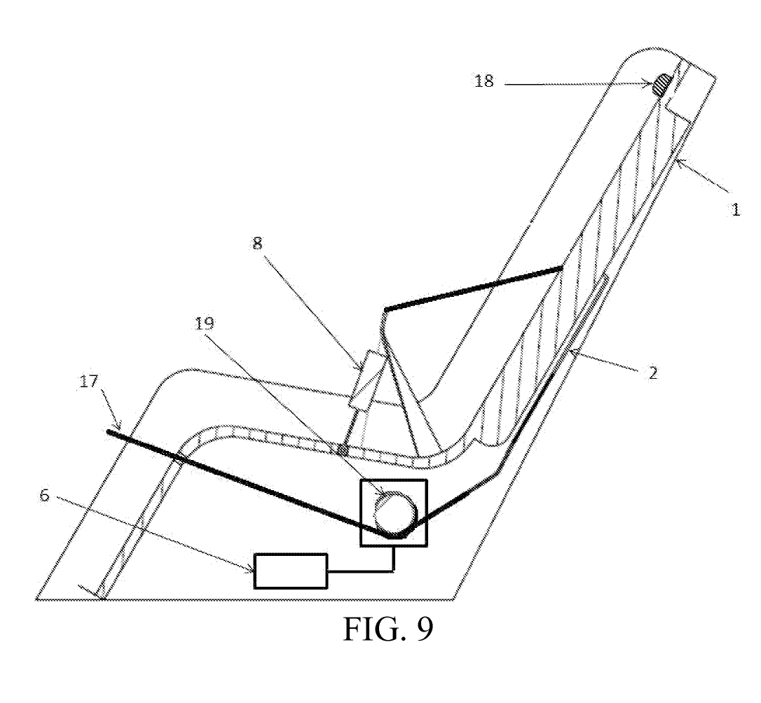

In FIGS. 4 to 6, 9 is an air pump; 10 are air cylinders; 11 are cylinder mounts; 12 are rod ends; 13 are pivot brackets; 14 is a pivot shaft; 15 are pivot arms; 16 is a tension roller; 17 is a manual tightening strap and 18 is an indication light.

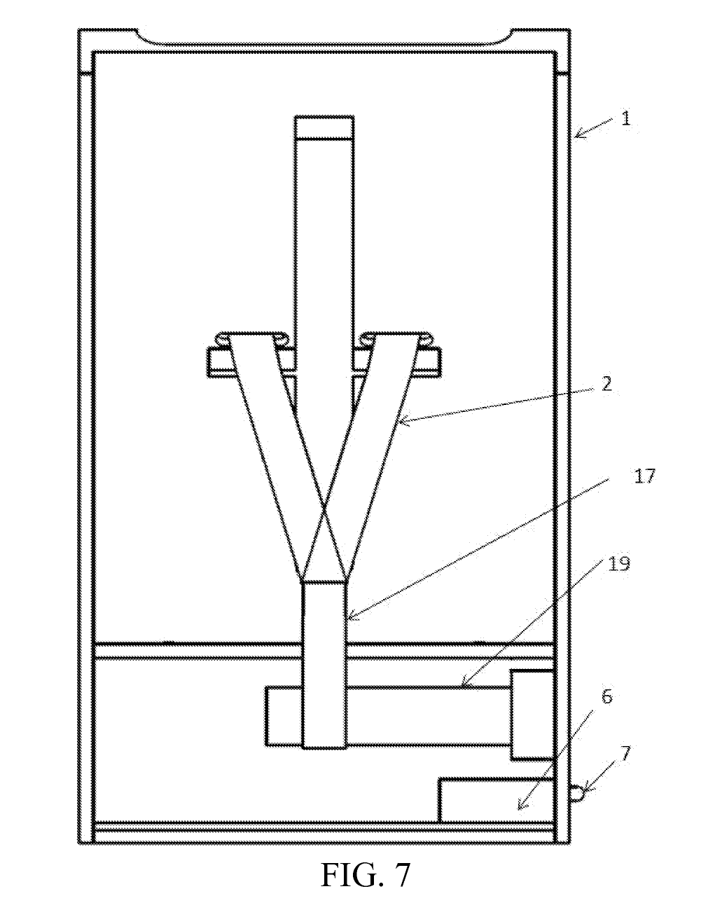

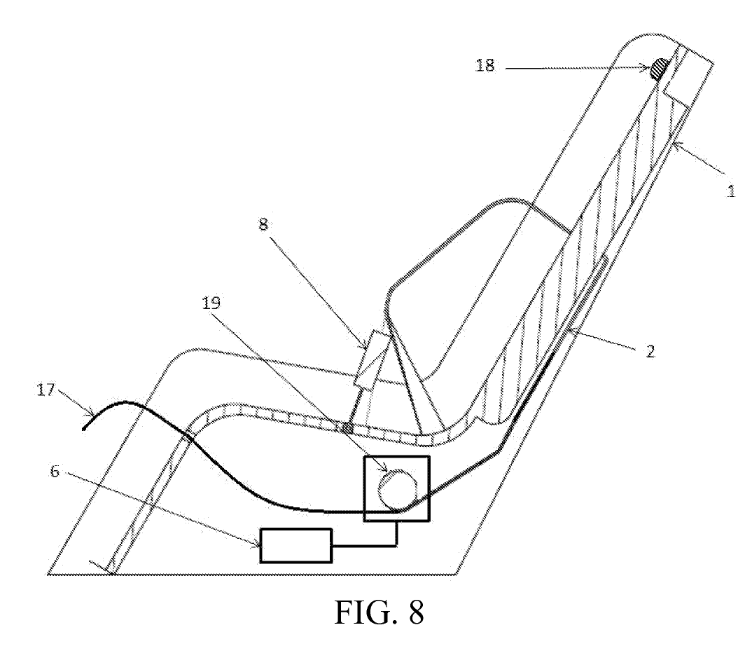

In FIGS. 7 to 9, 19 is a load cell tension roller.

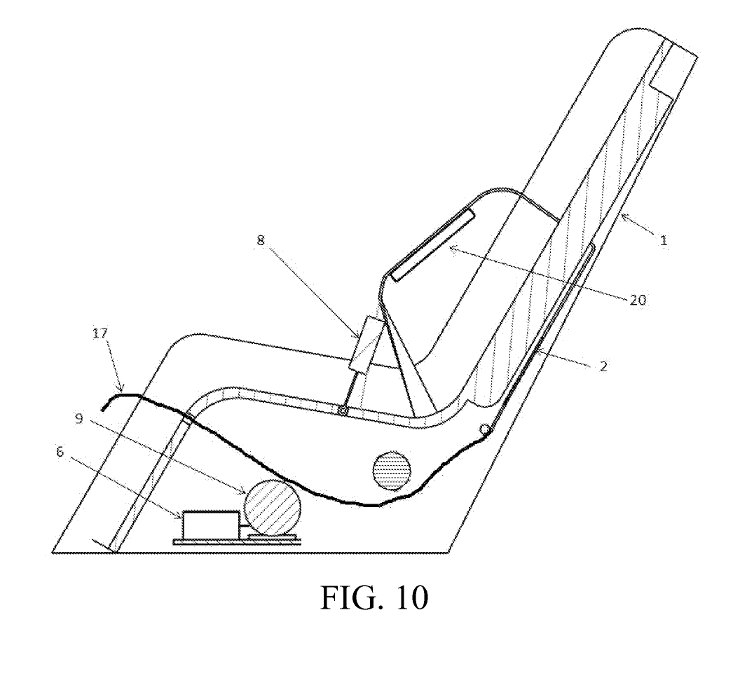

In FIG. 10, 20 are air bladders.

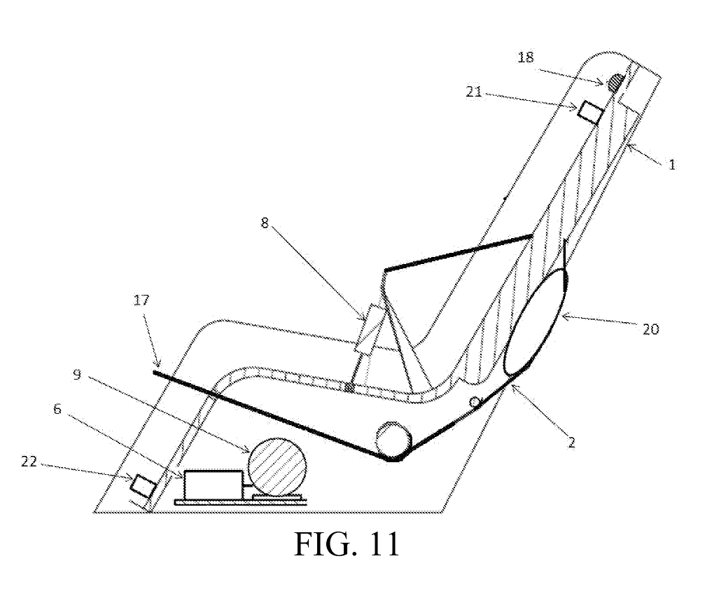

In FIG. 11, 21 is a relief valve and 22 is a manual control valve.

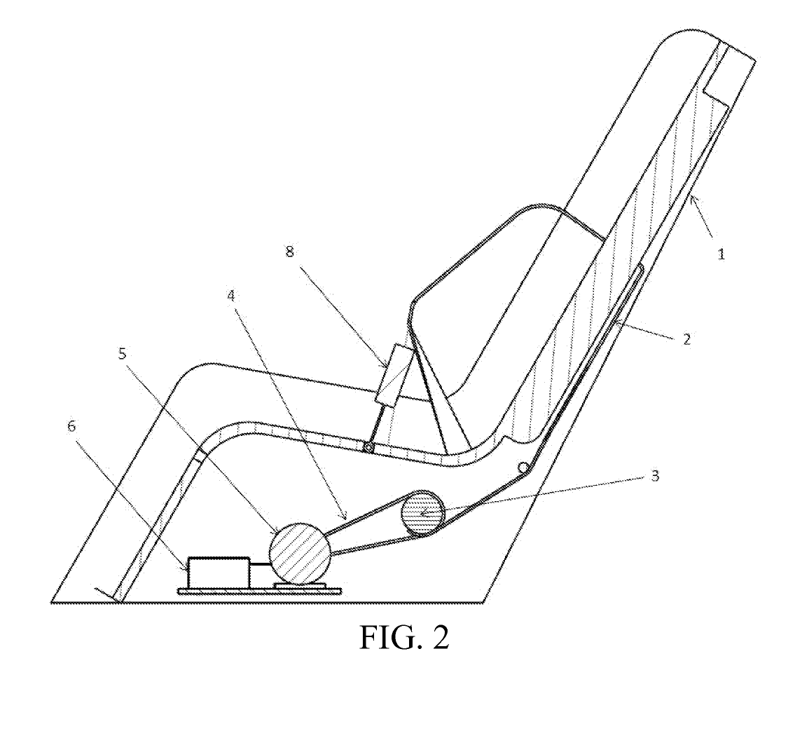

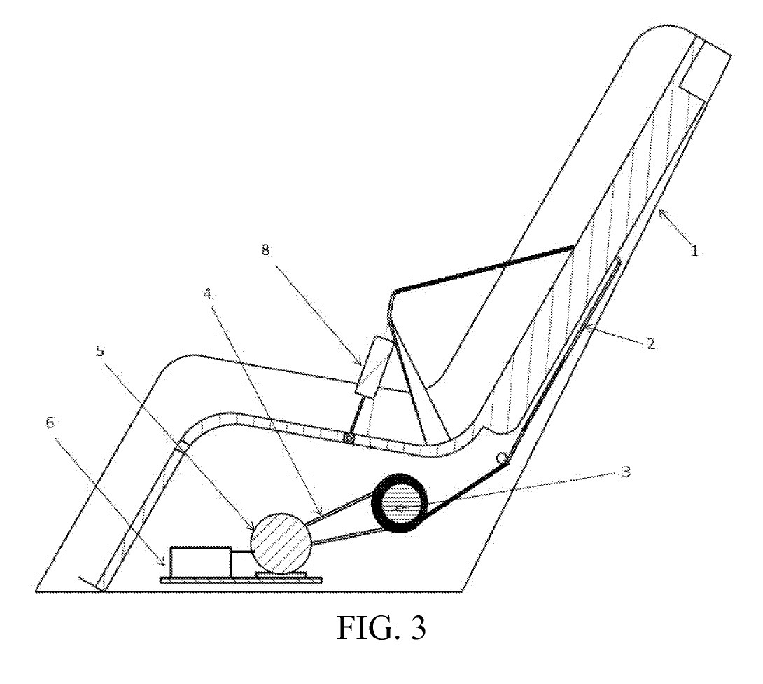

As seen in FIGS. 1 to 3, one way to tighten the safety harness straps automatically is by using an electric motor 5 to drive a windup shaft 3 which winds the strap or straps of the safety harness 2 about itself A switch 7 may be activated to power the motor 5 to begin rotating the windup shaft 3. As the output shaft of the motor 5 begins to the rotate, it begins to rotate the motor belt 4 which beings to rotate the windup shaft 3. As the windup shaft 3 rotates in one direction, the strap or straps begin to windup pulling the safety harness 2 tighter. The straps of the safety harness 2 may be connected to the windup shaft 3 in several different ways, but the connection must be strong enough to withstand the forces applied when tightening the harness and in the event of a car crash. Some ways to fix the strap to the shaft may include, but are not limited to using adhesives, bolts, clamps, pins or buckles. The speed at which the windup shaft 3 rotates should be relatively slow so the straps move smoothly over the child and through slots in the car seat 1. This speed can be controlled by motor selection (baseline RPM), gear reduction, for example with a gearbox or belt drive, or circuitry and programming by one of ordinary skill in the art. This circuitry, including a control unit or processor and power supply, may be housed in an electronics unit 6. Once the safety harness 2 has been tightened to a predetermined set point, the windup shaft 3 will stop rotating and remain fixed in its current radial position by either the motor, or with a locking mechanism, for example, a ratchet and pawn or brake. Alternatively, a slip clutch or other torque limiting device may be used as means to control the torque applied to the windup shaft 3. In one embodiment, the circuitry could measure or calculate the motor amps or torque required to produce proper tension in the safety harness 2. The control unit would then power the motor 5 until a predetermined level of torque had been reached. The circuitry then would alert the caretaker by any means disclosed herein that the safety harness 2 is properly tightened. A quick release (not shown) can be used to disengage the locking mechanism. The cross sectional views in FIGS. 2 and 3 show the before after sequence of this system.

Any practical means to wind the straps around a shaft are permissible. A belt driven system as shown in FIGS. 1 to 3 is one means, however, there are several other means that include, but are not limited to: a motor 5 may be directly coupled to the windup shaft 3, a gear may be mounted on the output shaft of the motor 5 which meshes with a gear mounted on the windup shaft 3, a motor 5 may be coupled to a gearbox which may be coupled to the windup shaft 3, or the output shaft of a motor 5 itself can be used as the windup shaft 3 in which the straps of the safety harness 2 are wound. Additionally, other parts, for example, a ratchet or crank, may be included with this system to fix or hold the windup shaft 3 in position after the motor 5 has finished tightening.

As seen in FIGS. 4 to 6, one means to tighten the safety harness automatically is using an air pump 9 to pressurize air cylinders 10 which apply force to a tension roller 16 which presses against the manual tightening strap 17. Alternatively, the air cylinders 10 may apply force or press directly against the straps of the safety harness 2 or the manual tightening strap 17. In operation, a caretaker may manually pull the manual tightening strap 17 for a quick, coarse adjustment before powering this automatic pneumatic system to finely adjust the tension in the straps of the safety harness 2 to the proper level of tightness. When the system is turned on, the air pump 9 will supply air to the air cylinders 10, not shown are air lines, tubing, fittings, and/or any standard materials or parts required to allow pressure to build in the air cylinders 10. This will extend the pistons of the air cylinders 10 causing the pivot arms 15 to rotate about the pivot shaft 14 fixed to the car seat 1 by pivot brackets 13. As the pivot arms 15 rotate clockwise, the tension roller 16 rotates towards and presses into the manual tightening strap 17. These brackets, shafts, rollers, etc. may be fabricated by any means known in the art, e.g., machining, injection molding, extrusion, etc. This pneumatic system may be deployed in any convenient location and assembled by a person of ordinary skill in the art and, alternatively, may press against the straps of the safety harness 2 in such a way to tighten the safety harness 2. The exact dimensions of the pivot arms 15, cylinder specifications, etc. may vary from car seat to car seat. The force applied by tension roller 16 on the manual tightening strap 17 will be in a direction that tightens or increase the tension on the safety harness 2.

Tension can be controlled by the circuitry in the electronic units 6 knowing the size of the cylinders 10, air pressure supplied by the air pump 9, etc. The circuitry would then indicate to the caretaker by means disclosed herein that the safety harness 2 is properly tightened once a predetermined level has been reached and that the air cylinders 10 had not reached its maximum stroke. Alternatively, constant force springs or torsion springs may be used similarly to provide a predetermined tension to the safety harness with a sensor to ensure the springs are not fully compressed.

As seen in FIGS. 7 to 9, the safety harness 2 connects to the manual tightening strap 17 in the back of the car seat 1 which then runs below the car seat 1 and through a slot in the front. As the caretaker pulls and manual tightening strap 17, it will eventually press against and slide over the load cell tension roller 19. This load cell tension roller 19 will measure the tension in the strap using technologies known in the art. This signal from the load cell tension roller 19 is sent to a processor in the electronics unit 6 to determine whether or not a set tension level in the strap or straps has been reached. Once the processor determines that the safety harness 2 is adequately tightened, a signal is sent to the indicating means, in these figures a light 18, to indicate to the caretaker that no more tightening is necessary. This system may feature a battery or some other power source which powers the indicating means. Other such indicating means include, but are not limited to speakers, sprayers, or vibrators. In addition or in lieu of the load cell tension roller 19, other instruments that may be used to detect proper tightening of the safety harness 2 include, but are not limited to strain gauges, load cells, and transducers. Additionally, this system may also feature an added safety feature to protect from over tightening the safety harness 2. That is, a separate indicating means, e.g., an additional different colored light, may illuminate when tension in the safety harness 2 reaches a too high or an unsafe level. This may be similarly controlled using the circuitry in the electronics unit 6 and may be used in any embodiment disclosed herein.

As seen in FIG. 10, an air pump 9 is used with air lines (not shown) that run to one or a plurality of air bladders 20 under the safety harness 2. When the switch 7 is activated, the air pump 9 inflates the air bladder 20 causing it to press against the safety harness 2 and a child's chest. This air bladder 20 will inflate until proper tension has been reached as determined by the circuitry of the electronics unit 6 or by or in addition to some other mechanical means such as, but not limited to relief valves, pressure sensors and pressure switches. Upon reaching a desired pressure, the air pump 9 may be automatically turned off and indication provided to the caretaker that the safety harness 2 had been properly tightened by means disclosed herein. In one embodiment, a pressure sensor could be used to measure the pressure in the air bladder 20 and circuity used to signal a light to turn on when the set pressure had been reached.

Coarse harness tightening may be done manually and the fine adjust can be done automatically with the air bladder 20 system. The air bladder 20 should be made of a suitable material and thickness to not rupture in the event of a car crash. The air bladder 20 is shown just above the lap buckle 8 and separate from the straps of safety harness 2, however, one or a plurality of air bladders 20 may be positioned elsewhere such that as they inflate, they tension the safety harness 2. Alternatively, the air bladder 20 could be large enough such that manual coarse tightening adjustment is not necessary. That is, once a caretaker buckles a child into the car seat 1, activating the switch 7 will inflate the air bladder 20 adequately enough to tighten the safety harness 2 to the proper tension without any need for manual adjustment. The air bladder 20 may be incorporated within the straps of safety harness 2 or as part of the chest cross bar (not shown). Alternatively, rather than using a powered air pump 9 to inflate the air bladder 20, a manual air pump may be used to manually inflate the air bladder 20. This pneumatic system may be an add-on feature to an existing car seat 1 or may come built into a new one.

As seen in FIG. 11, an air bladder 20 is positioned on the backside of the car seat 1 connected with air lines (not shown) to an air pump 9, relief valve 21, and manual control valve 22. When activated, the air pump 9 inflates the air bladder 20 causing it to press against the safety harness 2 and the car seat 1 thereby tightening the safety harness 2. The air bladder 20 inflates until proper tension has been reached as determined by a relief valve 21 or by some other means disclosed herein. Upon reaching a desired pressure, indication is provided to the caretaker by means disclosed herein and the air pump 9 may be manually or automatically turned off. To release the pressure from the air bladder 20, a caretaker may press the manual control valve 22 which vents air from the air bladder 20 and loosens the safety harness 2 allowing the caretaker to more easily unbuckle and remove a child from the car seat 1. Additionally, a locking mechanism may be used and positioned in such a way to keep the straps of the safety harness 2 properly tightened in case the air bladder 20 was to leak and lose pressure even after using the pneumatic systems disclosed herein. This locking mechanism may be automatically activated by circuitry in the electronics unit 6. These, and other pressure control and indication means could be employed by one skilled in the art and such variations fall within the scope of this invention.

As shown in FIGS. 1 through 11 mounted to the side of the car seat, a person of ordinary skill in the art may deploy the electronics unit 6 and switch 7 in any convenient location. Its circuitry and power supply may be located in separate locations, so long as they are communicatively coupled. Sensors may be used with the lab buckle 8 and chest cross bar to automatically activate the tightening system of the safety harness 2 once these connections have been made. That is, once the safety harness chest cross bar and the lap buckle 8 have been securely buckled, the circuity would power and initiate tightening of the safety harness 2. Circuitry and sensors could be also be used to maintain the pressure in the air bladders 20 well after the initial tightening sequence had been completed.

Non-limiting examples of the Figures and embodiments described herein are disclosed below. In Example 1, in reference to FIGS. 1-3, a battery powered electric motor was used to rotate a shaft or spindle with the safety harness winding about the shaft and tightening the safety harness. In this example, the car seat was a Peg Perego unit, the motor was a 12VDC unit geared down to a speed of about 36 RPM, and the windup shaft was a 0.25″ diameter stainless steel tube. Holes were drilled in the back underside of the car seat to locate and position the spindle in place. The motor was coupled directly to the spindle and the straps of the safety harness were fixed to the spindle using adhesive tape. With a fully loose safety harness, the motor was powered on and the safety harness straps began to wind about the spindle. The speed of the motor and size of the spindle resulted in a slow, smooth winding of the safety harness straps about the spindle. Different outer diameter spindles and spindle rotation speeds could be used. The straps continued to wind about the spindle until the safety harness had been properly tightened, as determined by the standard “pinch test” at which point the motor was powered off. The motor itself, when powered off, was sufficient to keep the safety harness taut when attempting to loosen it.

In Example 2, the motor was replaced with a battery powered drill (Ryobi P204) and the spindle was placed into the drill chuck and clamped snugly. Adjusting the torque indication on the drill provided a means to control the torque applied and likewise the tension in the straps. The lowest setting of level 1 on a scale from 1-24 was used and the speed of the drill was determined by how much the drill's trigger was squeezed. Slightly squeezing the trigger allowed for a slow and smooth rotation of the spindle causing the straps of the safety harness to wind about the spindle. The drill continued to wind the straps until the drill's torque setting had been reached indicated by a clicking sound. Checking the safety harness using a pinch test confirmed that the harness had been properly tightened. Adjusting the torque setting on the drill to level 24 proved to be too much as the tightness of the safety harness when reaching this level could be unsafe for an infant or child.

In Example 3, in reference to FIG. 10, different size and material air bladders were used with an air pump in different locations on a child car seat to tighten the safety harness. The air bladders used in this example were Qosina bags made from PVC, the air pressure source was an Eco-Plus Air 2 aquarium pump, and the bags were placed strategically around the safety harness of a Chicco KeyFit 30 infant car seat in such a way that inflation of the bag or bags pressed against the safety harness and a rigid surface. Standard air tubing and barbed fittings were used to make the connections between the devices. Using a 100 mL bag (Qosina 51494) positioned between the safety harness chest bar and a rigid object acting as a child's body and chest, the pump was turned on and the pressures in the bag were recorded. The safety harness was initially manually tightened to take up most of the slack, but still loose enough to form loops in the straps where the child's chest and collar bones would be. This check of forming loops in the straps is one of the car seat manufacturer's recommended tests to see if the car seat harness is properly tightened. If loops can be formed, than the safety harness is not tight enough. After this initial coarse adjustment, the pump was powered and pressure began to build in the air bladder. In this example, with pressures below 50″ of water in the air bladder, the harness was too loose as loops in the straps were still able to be formed. However, when reaching a pressure of 80″ of water in the air bladder, the safety harness had reached a proper level of tightening as loops were not able to be formed in the straps. After reaching this level, the pump was turned off and the pressure held constant in the air bladder keeping the safety harness properly tightened.

Using two 100 mL air bladders, one was placed under each shoulder strap of the safety harness between the straps and the rigid body in Example 4. Again after some initial coarse adjustment, the straps of the safety harness were able to reach the proper level of tightness when pressures in both air bladders reached 80″ of water.

In Example 5, using a 500 mL bag (Qosina 51530) placed between the safety harness chest bar and the rigid body, less initial coarse adjustment of the safety harness was needed due the higher volume capacity of the air bladder. That is, the larger the air bladder, the more slack the air bladder may take up in the safety harness. In this example, when pressures in the air bladder reached 20″ of water, the safety harness straps were properly tightened as loops were not able to be formed in the straps. Using only one port from the air pump, it took about 14 seconds to pressurize the air bladder to 20″ of water. When using both ports, the time taken to pressurize the air bladder to the same pressure was 7 seconds which is about half the time needed with one port as would be expected.

In Example 6, in reference to FIG. 11, a 500 mL bag was adhered and placed on the underside of the car seat between the safety harness straps and the car seat's body. A relief valve (McMaster-Carr 4277T5) set to 1 psi or 30″ of water was connected on one of the ports of the bladder to limit and control the pressure in the air bladder. This relief valve was positioned in the front of the car with tubing routed from the relief valve directly to one of the ports of the air bladder. A thin, plastic streamer was adhered to the venting end of the relief valve. After minor coarse adjustment of the safety harness, the system was powered turning the pump on and the pressure in the air bladder increased thereby tightening the safety harness until the pressure reached the limit set by the relief valve. Once reaching the designated pressure, the relief valve opened venting air and causing the streamer to extend from its original position. This visually verified that the air bladder had reached the pressure set by the relief valve and that the pump could now be turned off. Besides this visual means to indicate that the air bladder had reached the designated pressure, by merely placing one's hand over the exhaust end of the relief valve, one could physically feel the venting air flow. To relieve the pressure after the system was turned off, a manual control valve (McMaster-Carr 62475K13) connected from one of the ports from the air bladder was activated releasing the pressurized air from the bladder. This allows a caretaker to then easily unbuckle the safety harness and remove a child from the car seat. This process was duplicated with an 8 month old infant placed in the car seat replacing the rigid body resulting in a properly tightened harness.

In Example 7, two 500 mL air bladders were stacked between the underside of the car seat and the safety harness straps where no manual adjustment was needed as the volume of the two air bladders was enough to properly tighten the harness when initially fully loose.

In Example 8, a less rigid, more inflatable air bladder (Bontrager 700x18c-23c) was used between the rigid body and the safety harness straps in Example 8. The pressure needed to properly tighten the safety harness was much greater than with the more rigid bladders as about 30 psi was needed. In this example, more pressure was needed since this bladder significantly expanded beyond its unpressurized volume and was too compliant at lower pressures.

The invention described is not just limited to the illustrated embodiments. This invention encompasses every possible combination of the features of each embodiment and modifications or variations of the illustrated drawings herein. Other configurations could be devised by those skilled in the art and such modifications or variations of these embodiments fall within the spirit and scope of this invention.

What is claimed:

1. A device to automatically tension a child car seat safety harness to the proper level of tightness.

2. The device of claim 1 comprising a means to lock and release tension on the car seat safety harness.

3. The device of claim 1 comprising a mechanical means for tightening the harness wherein the means for automatically tightening the car seat safety harness comprises an electric motor.

4. The device of claim 3 wherein said electric motor rotates a spindle which the car seat safety harness winds itself on.

5. The device of claim 3 wherein said electric motor powers other means known to those skilled in the art to tighten the car seat harness.

6. The device of claim 1 wherein the means for tightening the car seat safety harness is an electric air pump.

7. The device of claim 6 wherein said air pump actuates cylinders to tighten the car seat safety harness.

8. The device of claim 6 wherein said air pump pneumatically inflates air bladders built within or apart from the car seat safety harness.

9. The device of claim 6 wherein said air pump pneumatically inflates bladders built within the car seat safety harness chest buckle.

10. The device of claim 1 wherein the pneumatic means for tightening the car seat safety harness comprises one or a plurality of pressurized cylinders.

11. The device of claim 1 wherein the pneumatic means for tightening the car seat safety harness comprises a manual air pump.

12. The device of claim 1 wherein the mechanical means for tightening the car seat safety harness comprises one or a plurality of springs.

13. A device of claim 1 additionally comprising a means to indicate that a car seat safety harness has been properly tightened.

14. The device of claim 13 wherein the means for indicating proper tightness comprises one or a plurality of lights.

15. The device of claim 13 wherein the means for indicating proper tightness comprises one or a plurality of audio speakers or sound emitting devices.

16. The device of claim 13 wherein the means for indicating proper tightness comprises one or a plurality of vibrators.

17. The device of claim 13 wherein the means for indicating proper tightness comprises one or a plurality of sprays or odor generating devices.

18. A car seat comprising a device of claim 1.

19. The car seat of claim 18 further comprising a means for indicating proper tightness of the car seat safety harness.

20. The car seat of claim 18 further comprising a means to lock and release tension on the car seat safety harness.
